(19) United States
(12) Patent Application Publication
(10) Pub. No.: US 2019/0181744 A1
(43) Pub. Date: Jun. 13, 2019

(54) BUS CONVERTER CURRENT RIPPLE REDUCTION

(71) Applicant: TEXAS INSTRUMENTS INCORPORATED, Dallas, TX (US)

(72) Inventor: Isaac Cohen, Dix Hills, NY (US)

(21) Appl. No.: 15/912,241

(22) Filed: Mar. 5, 2018

Related U.S. Application Data
(60) Provisional application No. 62/596,960, filed on Dec. 11, 2017.

(51) Int. Cl. H02M 1/14; H02M 3/335; H02M 3/158; H02M 1/084; H02M 1/12

(52) U.S. Cl. CPC H02M 1/146; H02M 3/33515; H02M 1/12; H02M 1/084; H02M 3/1588

(57) ABSTRACT

In described examples, a circuit includes a first, a second, and a third resonant power converter. Each of the first, second, and third resonant power converters includes a respective periodic signal generator, a respective resonant network, and a respective rectifier. Each periodic signal generator is coupled to receive a direct-current (DC) power input and a respective phase signal. Each resonant network is coupled to receive a sinusoidal output current from the respective periodic signal generator. Each rectifier is coupled to receive a sinusoidal output current from the respective resonant network. The circuit further includes a current summer coupled to receive a rectified current from each respective rectifier.

### CROSS-REFERENCE TO RELATED APPLICATION

This application claims the benefit of U.S. Provisional Patent Application No. 62/596,960, filed Dec. 11, 2017, which is incorporated herein by reference in its entirety and for all purposes.

### BACKGROUND

Electronic devices are increasingly used in a great diversity of applications for which switching-type power converters are called upon to operate more efficiently and with greater power conversion density. Switching power supplies include magnetic components such as power transformers and/or inductors. Power transformers can increase or decrease an output voltage of the power converter with respect to its input voltage and can also provide electrical circuit isolation between components coupled to its primary winding and components coupled to its secondary winding. Inductors can be employed to filter an input current or an output current of a switching-type power converter. However, the magnetic components in switching power converters generally occupy a substantial volume of the switching power converters and can increase the size and weight of the switching power supplies when employed in a design.

### SUMMARY

In described examples, a circuit includes a first, a second, and a third resonant power converter. Each of the first, second, and third resonant power converters includes a respective periodic signal generator, a respective resonant network, and a respective rectifier. Each periodic signal generator is coupled to receive a direct-current (DC) power input and a respective phase signal. Each resonant network is coupled to receive a sinusoidal output current from the respective periodic signal generator. Each rectifier is coupled to receive a sinusoidal output current from the respective resonant network. The circuit further includes a current summer coupled to receive a rectified current from each respective rectifier.

### BRIEF DESCRIPTION OF THE DRAWINGS

FIG. 1 is a block diagram of a computing device powered by an example low ripple power converter.

FIG. 2 is a block diagram of an example low ripple power converter.

FIG. 3 is a schematic diagram of an example low ripple power converter.

FIG. 4 is a waveform diagram showing simulation waveforms of an example low ripple power converter operating with no phase shifting of respective series resonant converter outputs.

FIG. 5 is a waveform diagram showing simulation waveforms of an example low ripple power converter including one-third-wave phase shifting of respective series resonant converter outputs.

### DETAILED DESCRIPTION

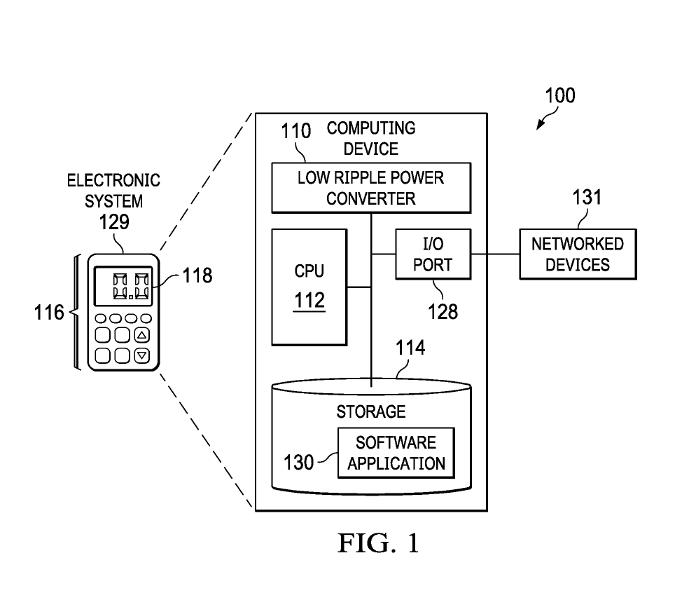

FIG. 1 is a block diagram of a computing device 100 powered by an example low ripple power converter. For example, the computing device 100 is, or is incorporated into, or is coupled (e.g., connected) to an electronic system 129, such as a computer, electronics control “box” or display, communications equipment (including transmitters or receivers), or any type of electronic system operable to process information.

In some examples, the computing device 100 comprises a megacell or a system-on-chip (SoC) that includes control logic such as a CPU 112 (Central Processing Unit), a storage 114 (e.g., random access memory (RAM)) and a low ripple power converter 110. The CPU 112 can be, for example, a CISC-type (Complex Instruction Set Computer) CPU, RISC-type CPU (Reduced Instruction Set Computer), MCU-type (Microcontroller Unit), or a digital signal processor (DSP). The storage 114 (which can be memory such as on-processor cache, off-processor cache, RAM, flash memory, or disk storage) stores one or more software applications 130 (e.g., embedded applications) that, when executed by the CPU 112, perform any suitable function associated with the computing device 100. The processor is arranged to execute code for transforming the processor into a special-purpose machine having the structures—and for performing the operations—described herein.

The CPU 112 comprises memory and logic that store information frequently accessed from the storage 114. The computing device 100 is often controlled by a user using a UI (user interface) 116, which provides output to and receives input from the user during the execution the software application 130. The output can include indicators such as the display 118, indicator lights, a speaker, and vibrations. The input can include sensors for receiving audio and/or light (using, for example, voice or image recognition), and can include electrical and/or mechanical devices such as keypads, switches, proximity detectors, gyros, and accelerometers.

The CPU 112 and low ripple power converter 110 are coupled to I/O (Input-Output) port 128, which provides an interface that is configured to receive input from (and/or provide output to) networked devices 131. The networked devices 131 can include any device (including test equipment) capable of point-to-point and/or networked communications with the computing device 100. The computing device 100 can be coupled to peripherals and/or computing devices, including tangible, non-transitory media (such as flash memory) and/or cabled or wireless media. These and other such input and output devices can be selectively coupled to the computing device 100 by external devices using wireless or cabled connections. The storage 114 is accessible, for example, by the networked devices 131. The CPU 112, storage 114, and low ripple power converter 110 are also optionally coupled to an external power source (not shown), which is configured to receive power from a power source (such as a battery, solar cell, “live” power cord, inductive field, fuel cell, capacitor, and energy storage devices).

The low ripple power converter 110 includes power generating and control components for generating power to energize the computing device 100 to execute the software application 130. The low ripple power converter 110 is optionally included in the same physical assembly as computing device 100, or alternatively coupled to computing device 100. The computing device 100 optionally operates in various power-saving modes in which individual voltages are supplied (and/or turned off) in accordance with a selected power-saving mode and the various components thereof being arranged within a selected power domain.

The low ripple power converter 110 described herein is a switched-mode power converter that is arranged to convert and output energy via magnetic or capacitive circuit elements. The power converters described herein are arranged to receive a direct current (DC) voltage (or other kinds of voltages) as an input voltage. Energy derived from the input voltage can be temporarily stored in energy storage devices (such as an inductors and capacitors of a power converter) during each resonant cycle. A filter can be used to reduce ripple in the input and/or output DC voltage and current.

In a series resonant power converter (e.g., a resonantly switched DC-DC power converter) operated at or substantially near its resonant frequency, the output voltage Vout is a function of its input voltage and the transformer-turns ratio. The resonant frequency of a resonant power converter is dependent upon the leakage inductance of the transformer (which is present both in the primary and the secondary windings), as well as a capacitor in series coupled to a winding of the power transformer, such as a primary winding. A resonant power converter can be operated at or very near its resonant frequency fₛ (e.g., at which point its power conversion efficiency is usually high). In an example, the resonant frequency of a series resonant power converter is about 750 KHz, and the power converter is operated at a switching frequency of 750 kHz.

As described herein, a low ripple power converter includes phase-synchronized (e.g., phase-shifted) resonant power converters coupled in parallel and resonantly switched at a common switching frequency fₛ. A switching phase of each of the resonant power converters differs (e.g., leads or lags by 120°) with respect to a switching phase of another of the resonant power converters. For example, current summation of each alternating-current (AC) output of the phase-offset outputs of the resonant power converters causes power supply ripple in each individual AC output to be reduced (if not virtually eliminated) by effects of mutual-cancellation by the ripple in each of the phase-offset outputs. The reduced-ripple output of the low ripple power converter can be generated without (for example) including large filtering circuits for reducing relatively large amounts of ripple. Substantial reduction of input and output filter capacitances can be achieved with lower cost and higher power density for the low ripple power converter.

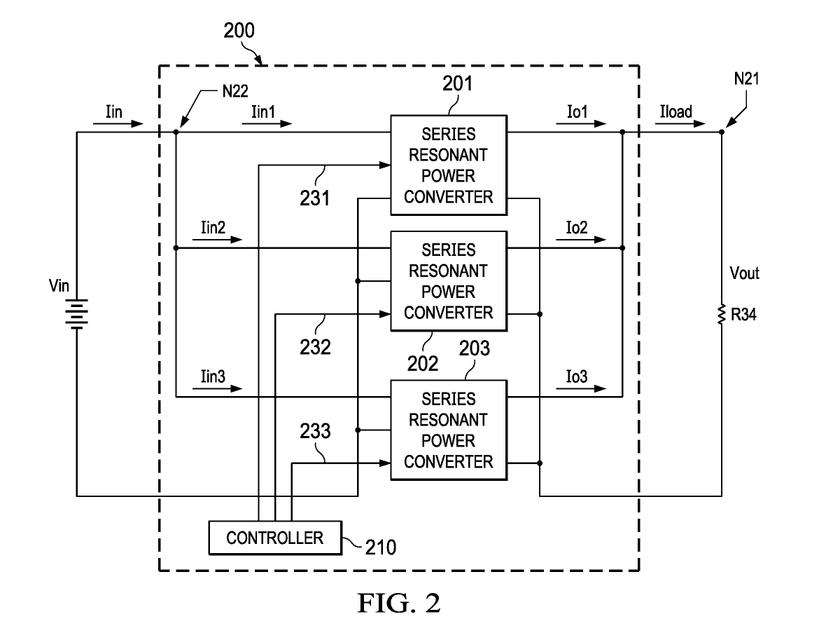

As described hereinbelow with reference to FIG. 2, three individual resonant power converters are arranged to operate in parallel in a three-phase (and/or an integer multiple of three-phase) arrangement where each resonant power converter is responsive to a three-phase synchronization signal to generate an output waveform (e.g., voltage or current waveform) that leads or lags a respective output waveform of one of the other two individual resonant power converters. The ripple current component (e.g., AC component) of each resonant power converter output (as well as the ripple current component of each input) is mutually reduced by the ripple current component of each of the other two resonant power converters.

FIG. 2 is a block diagram of an example low ripple power converter. The example low ripple power converter 200 is a power converter such as the low ripple power converter 110. The power converter 200 is a power conversion circuit that includes a first series resonant power converter 201, a second series resonant power converter 202, and a third series resonant power converter 203. Such resonant power converters can be referred to as “LLC” (inductor-inductor-capacitor) power converters.

A resonant power converter can be operated at or near its resonant frequency fₛ (e.g., at which point its power conversion efficiency is usually high). Each of the example first, second and third resonant power converters 201, 202 and 203 is a series resonant power converter arranged to virtually (e.g., nearly) operate at resonance under all conditions (e.g., all load conditions). Because the example first, second and third resonant power converters 201, 202 and 203 each operate at resonance with respective phase differences of 120° (e.g., leading or lagging by 120°), the sum of currents is ideally constant over time without current fluctuations.

As described herein, each of the example first, second and third resonant power converters 201, 202 and 203 includes a transformer (e.g., which is isolated from the transformers of the other two power converters) that is arranged to switch at conditions of zero volts and zero current (e.g., under all load conditions). In an example, the first, second and third resonant power converters 201, 202 and 203 each singly perform switching operations in accordance with zero voltage switching (ZVS) and zero current switching (ZCS). The example zero voltage switching occurs at voltage conditions less than 10 percent of the voltage difference between a maximum voltage and ground of a voltage waveform being switched, and the example zero current switching occurs at amperage conditions of less than 10 percent of a maximum current of a current waveform being switched.

Each of the three series resonant power converters 201, 202 and 203 are similarly arranged, such that performance of one of the resonant power converters 201, 202 and 203 is similar to the other two of the resonant power converters 201, 202 and 203. For example, as a result of operating at the series resonant frequency, each converter draws a sinusoidal current (e.g., virtually sinusoidal current) from the input and delivers a sinusoidal current to the respective output rectifier. The three series resonant power converters 201, 202 and 203 are driven at a same (e.g., master) frequency and with each respective control signal phase shifted with a lead or lag of 120 degrees with respect to the other two control signals. Each of the three series resonant power converters 201, 202 and 203 can include a full-wave rectifier for rectifying a received sinusoidal current and for generating a rectified current, such that the rectified currents can be summed to generate a DC output voltage.

The symmetrical arrangement of the low ripple power converter 200 helps ensure each input current at an input node is nearly equal (albeit phase-shifted) to the other input currents. The symmetrical arrangement also helps ensure each output current at an output node is nearly equal (albeit phase-shifted) to each of the other output currents. The nearly equal amounts of phase shifting (e.g., of 120 degrees) helps ensure the sum of the rectified currents at any point in time is virtually zero at the output node. The virtually zero sum (e.g., from time summation) of sinusoidal currents at the output node substantially reduces the AC components (ripple) present in the output current, which in turn reduces power dissipation and permits the use of less expensive capacitive and inductive components. The output currents of each of the resonant power converters 201, 202 and 203 can be nearly equal (e.g., within 10 percent of each other) at similar phase-angles when the values of corresponding components of the resonant power converters 201, 202 and 203 are the same within a range of manufacturing tolerances.

The three series resonant power converters 201, 202 and 203 are coupled in parallel to input voltage source Vin at input node N22. Output currents produced by the first, the second, and the third series resonant power converters 201, 202 and 203 are summed at an output current summing node N21 for generating a total output current Iload, such that the total output current Iload is the sum of the output currents Io1, Io2 and Io3. The output currents Io1, Io2 and Io3 are coupled to load R34.

Correspondingly, the total input current Iin at the input node N22 to the power converter is the sum of output currents Iin1, Iin2 and Iin3 drawn from the input voltage source Vin by each of the resonant power converters 201, 202 and 203. The nearly equal amounts of phase shifting (e.g., of 120 degrees) helps ensure the sum of the input currents at any point in time is virtually zero at the input node N22.

The controller 210 provides MOSFET switching control signals 231, 232 and 233 to control conduction states of a respective MOSFET power switches for each resonant power converter of 201, 202 and 203. The controller 210 delays the switching control signal 232 for the resonant power converter 202 by one-third of a switching cycle (at the frequency fₛ) with respect to switching control signal 231 for the power converter 201. The controller 210 delays the switching control signal 233 for the resonant power converter 203 by two-thirds of the switching cycle with respect to switching control signals for the power converter 201. Accordingly, the substantially sinusoidal (AC component) ripple current produced by each of the three resonant power converters are successively delayed by one third of a switching cycle before they are summed at the output node N21. In an example comparison, the magnitude of the AC components in the sum of the currents is lower by a factor of at least 10 than the magnitude of the AC components produced by a single phase converter of equal power (e.g., as measured peak-to-peak of the AC components in the output current).

Correspondingly, ripple currents drawn at the input node N22 are also substantially canceled (e.g., reduced) in response to summing of successively delayed sinusoidal waveforms of the input currents Iin1, Iin2 and Iin3.

Cancellation of ripple currents drawn at the input node N22 and sourced at the output node N21 substantially reduces the capacitance (e.g., as well as the physical size of the capacitor) selected to filter the output voltage Vout (as well as the input voltage Vin) of the power converter in accordance with application design specifications.

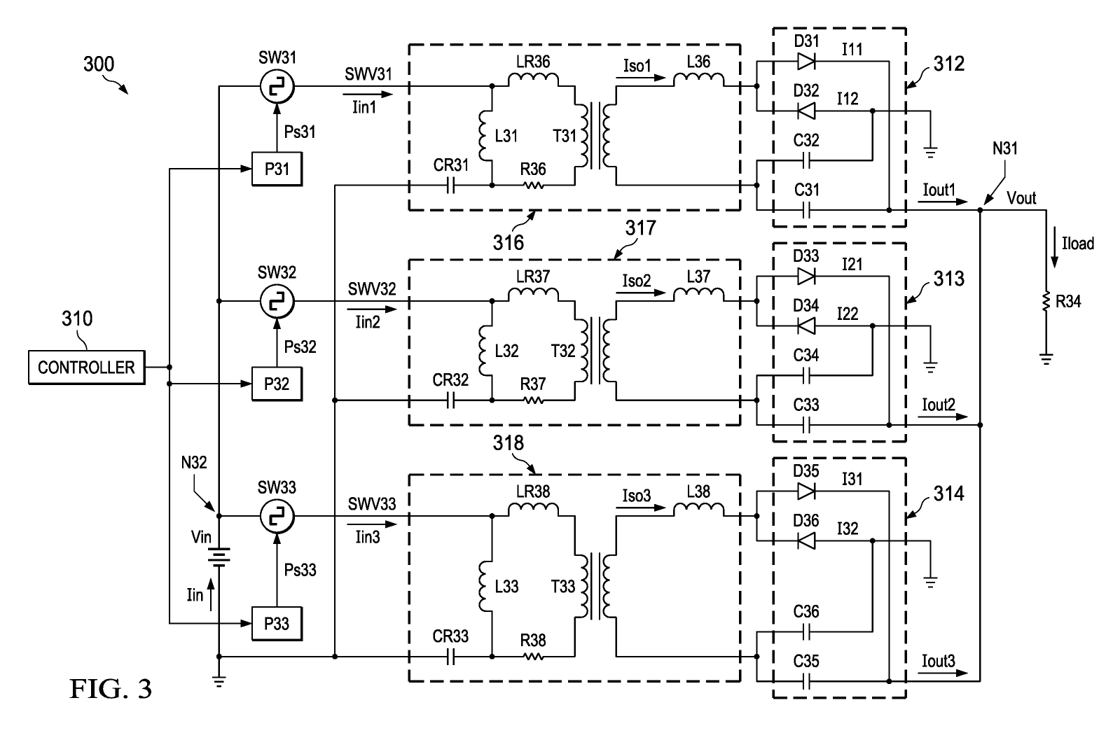

FIG. 3 is a schematic diagram of an example low ripple power converter. The example power converter 300 is a power converter such as the low ripple power converter 200. The power converter 300 is a power conversion circuit that includes: a first resonant power converter that includes a first resonant network 316 and a first rectifier circuit 312; a second resonant power converter that includes a second resonant network 317 and a second rectifier circuit 313; and a third resonant power converter that includes a third resonant network 318 and a third rectifier circuit 314.

The first resonant power converter includes a periodic signal generator (such as the first square wave generator SW31) for generating a first periodic voltage (such as the square wave voltage SWV31) in response to a direct-current (DC) power input (Vin) and a first phase signal Ps31. In an example, the periodic voltage includes a repeating waveform in which the waveform includes a first substantially constant voltage for a first time period and a second substantially constant voltage (e.g., ground) for a second time period. The first square wave generator SW31 includes power metal-oxide-semiconductor field-effect transistors (MOSFETs) that are coupled between an input voltage source Vin and a local circuit ground. The power MOSFETs are each switched by the controller 310 at a substantially 50% duty cycle at the switching frequency fₛ but with opposite phase, such that a first given MOSFET is turned on while the other MOSFET is turned off.

The first resonant power converter also includes the first resonant network 316, which is arranged to generate a first sinusoidal output current Iso1 in response to the first square wave voltage SWV31. The first resonant power converter also includes a rectifier circuit 312, which includes a first rectifier pair D31 and D32 arranged as a voltage doubler (other configurations are possible) to cooperatively rectify the first sinusoidal output current Iso1 to generate a first output current Iout1.

The first resonant power converter also includes magnetizing inductance L31 of transformer T31, leakage (or added) inductance LR36 referenced to or coupled to the primary winding of transformer T31, resistor R36 to model effective resistance of transformer T31, and leakage inductance L36 referenced to the secondary winding of transformer T31. Example values of inductance of inductor LR36 is 0.09 μH, of leakage inductance L36 is 7.5 nH, of resistance of resistor R36 is 50 milliohms and of capacitance of capacitor CR31 is 133 nF. Example values of capacitance of capacitors C31 and C32 are 10 μF and 3.5 μF, respectively.

The second resonant power converter includes a periodic signal generator (such as the second square wave generator SW32) for generating a periodic voltage (such as the second square wave voltage SWV32) in response to the direct-current (DC) power input (Vin) and a second phase signal Ps32. The second resonant power converter further includes a second resonant network 317, which is arranged to generate a second sinusoidal output current Iso2 in response to the second square wave voltage SWV32. The second resonant power converter also includes a rectifier circuit 313, which includes a second rectifier pair D33 and D34 arranged as a voltage doubler to cooperatively rectify the second sinusoidal output current Iso2 to generate a second output current Iout2.

The second resonant power converter further includes magnetizing inductance L32 of transformer T32, leakage (or added) inductance LR37 referenced to or coupled to the primary winding of transformer T32, resistor R37 to model effective resistance of transformer T32, and leakage inductance L37 referenced to the secondary winding of transformer T32. Example values of inductance of inductor L32 is 0.09 μH, of leakage inductance L37 is 7.5 nH, of resistance of resistor R37 is 50 milliohms and of capacitance of capacitor CR32 is 133 nF. Example values of capacitance of capacitors C33 and C34 are 10 μF and 3.5 μF, respectively.

The third resonant power converter includes a periodic signal generator (such as the third square wave generator SW33) for generating a periodic voltage (such as the third square wave voltage SWV33) in response to the direct-current (DC) power input (Vin) and a third phase signal Ps33. The third resonant power converter further includes a third resonant network 318, which is arranged to generate a third sinusoidal output current Iso3 in response to the third square wave voltage SWV33. The third resonant power converter also includes a rectifier circuit 314, which includes a third rectifier pair D35 and D36 arranged as a voltage doubler to cooperatively rectify the third sinusoidal output current Iso3 to generate a third output current Iout3.

The third resonant power converter further includes magnetizing inductance L33 of transformer T33, leakage (or added) inductance LR38 referenced to or coupled to the primary winding of transformer T33, resistor R38 to model effective series resistance of transformer T33, and leakage inductance L38 referenced to the secondary winding of transformer T33. Example values of inductance of inductor LR38 is 0.09 μH, of leakage inductance L38 is 7.5 nH, of resistance of resistor R38 is 50 milliohms and of capacitance of capacitor CR33 is 133 nF. Example values of capacitance of capacitors C35 and C36 are 10 μF and 3.5 μF, respectively.

The power converter 300 includes a current summer, shown as the circuit node N31, which is arranged to generate a total output current Iload in response to summing the first, second and third output currents Iout1, Iout2 and Iout3. In the example shown by the circuit node N31, the current summer is a wired connection.

The ripple of the first sinusoidal output current Iso1 of the first output current Iout1, the ripple of the second sinusoidal output current Iso2 of the second output current Iout2 and the ripple of the third sinusoidal output current Iso3 of the third output current Iout3 are substantially mutually canceled by the current summer at the circuit node N31.

The first phase signal Ps31 indicates a phase difference of 120 degrees (or −240 degrees) from a phase indicated by the second phase signal Ps32 and a phase difference of 240 degrees (or −120 degrees) from a phase indicated by the third phase signal Ps33.

The first sinusoidal output current Iso1 includes a phase difference of 120 degrees from a phase of the second sinusoidal output current Iso2 and a phase difference of 240 degrees from a phase of the third sinusoidal output current Iso3.

In an example, the first output current Iout1 is nearly equal to the second output current Iout2 and the first output current Iout1 is nearly equal to the third output current Iout3 (at similar phase angles).

The power converter further includes a phase generator, which is shown collectively as the phase generators P31, P32 and P33, which are arranged to respectively generate the first, second and third phase signals Ps31, Ps32 and Ps33. The first phase signal Ps31 indicates a phase difference of 120 degrees from a phase indicated by the second phase signal Ps32 and a phase difference of 240 degrees from a phase indicated by the third phase signal Ps33. The phase generators P31, P32 and P33 are mutually synchronized (e.g., with respect to respective phase relationships) in response to control signals generated by controller 310. In other examples, the controller 310 can generate the phase signals Ps31, Ps32, and Ps33 directly (e.g., without a phase generator).

The input voltage can be generated by a DC power supply as illustrated in FIG. 3 by the battery producing the input voltage Vin.

The example power converter 300 is coupled to a resistive load R34, which is arranged to convert the total output current Iload into the output voltage Vout. The resistive load R34 can be a system, such as system 100 described hereinabove.

The first, second and third resonant networks 316, 317 and 318, respectively include resistors R36, R37 and R38. The resistors R36, R37 and R38 are resistors for modelling the effective series resistance of the coil windings associated with the first, second and third resonant power converters.

The total input current Iin at the input node N32 to the power converter 300 is the sum of currents Iin1, Iin2 and Iin3 drawn from the input voltage source Vin by each of the first, second and third resonant power converters. As described hereinabove, ripple currents that would otherwise be introduced into the input voltage source Vin are substantially reduced in response to the mutual ripple cancelation of the current summer node N31.

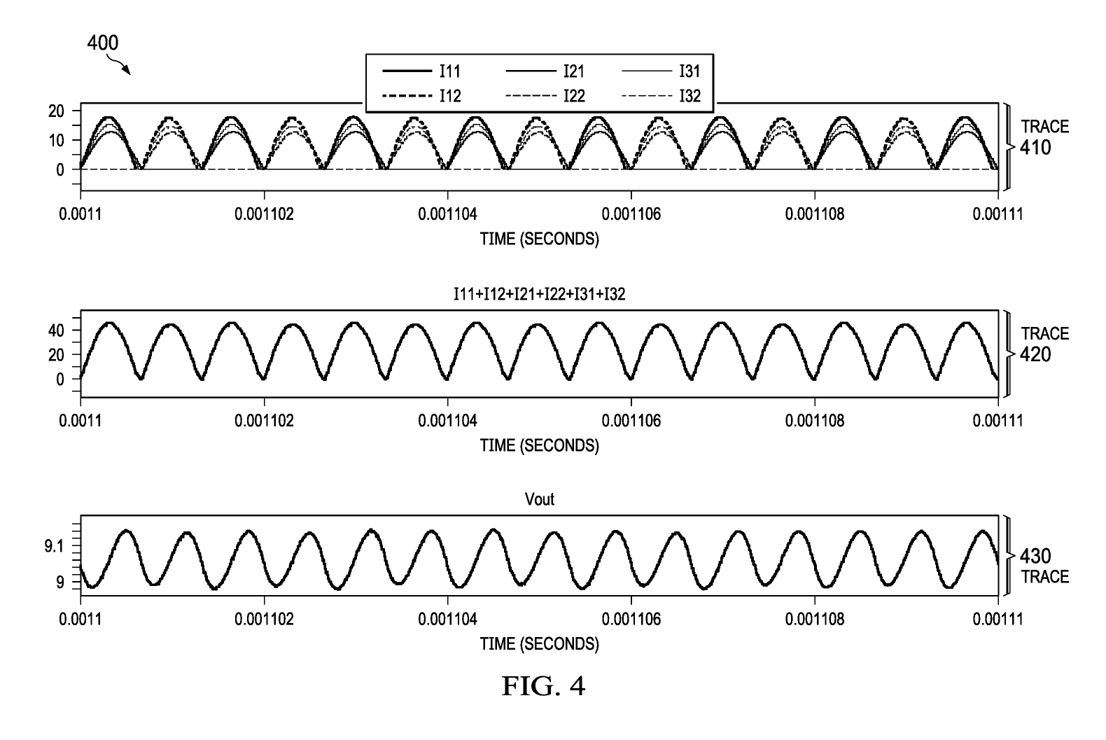

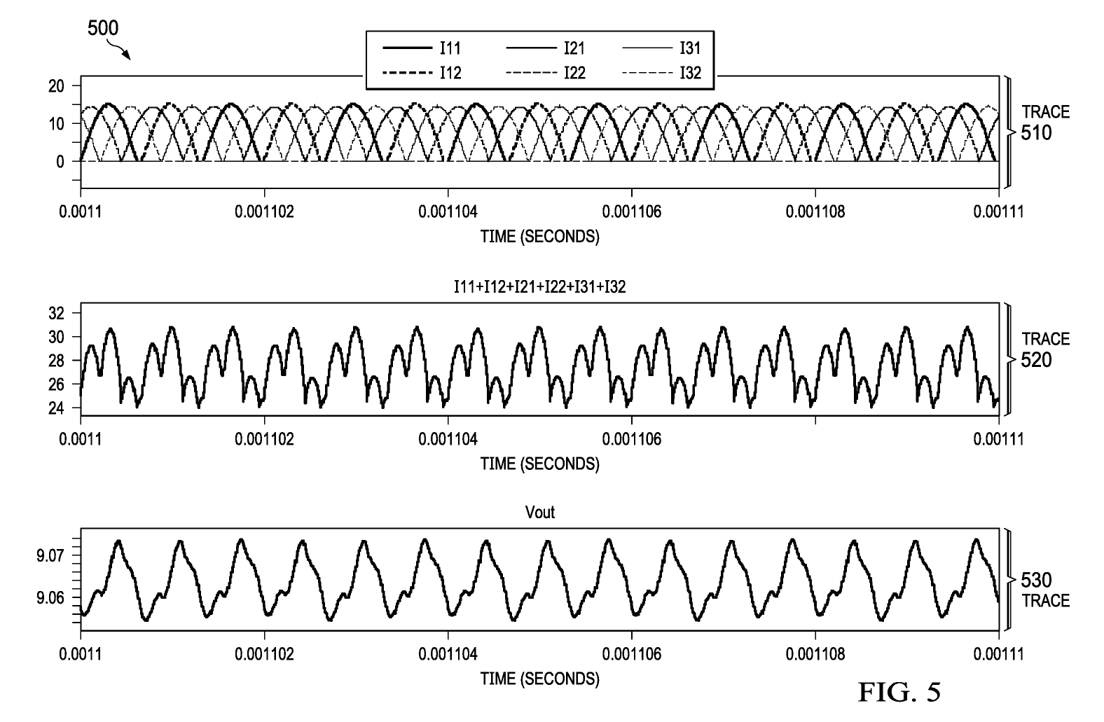

FIG. 4 is a waveform diagram showing simulation waveforms of an example power converter operating with no phase shifting of respective series resonant converter outputs. The simulated power converter is a power converter similar to the power converter 300, albeit with no phase shifting of the input wave forms and varying component values. In the example simulation, tolerances of 10 percent in the values of resonant inductors is assumed (e.g., without tolerances, the sum of the currents could otherwise result in a preferred ripple cancelation when the input waveforms lead or lag by 120°, as described herein below with respect to FIG. 5, for example). In the trace 410, the magnitude, phase relationships and time scale of the output currents produced by the first, second and third series resonant power converters are shown.

In FIG. 4, the rectifier diode currents I11, I12, I21, I22, I31, and I32 (of FIG. 3) are shown by simulation results in which each of the series resonant converters (e.g., 201, 202, and 203) operated in-phase (e.g., for purposes of comparison with corresponding waveforms of FIG. 5 described hereinbelow, which instead shows simulation results in response to respective 120° phase shifts for each of the series resonant converters). Each diode current I11, I12, I21, I22, I31, and I32 is substantially half sinusoidal when forward-conducted. The trace 410 shows that each diode current (when forward-conducted) includes a maximum value of around 20 amperes.

The trace 420 shows the summed diode currents waveform, which shows the sum of the contributions of the diode currents I11, I12, I21, I22, I31, and I32. The summed secondary currents waveform indicates current that ranges from zero to over 40 amperes.

The trace 430 shows the resulting (e.g., simulated) output voltage ripple of the output voltage Vout that is generated in response to a resistive load (e.g., R34), the capacitors C31, C32, C33, C34, C35, and C36, and the summed secondary currents waveform of trace 420. The ripple of the output voltage Vout is a ripple of more than 120 millivolts.

FIG. 5 is a waveform diagram showing simulation waveforms of an example low ripple power converter including one-third wave phase shifting of respective series resonant converter outputs. The simulated power converter is a power converter similar to the power converter 300 (e.g., with varying component values). The waveform trace 510 shows each forward-conducted, substantially sinusoidal diode current I11 and I12 at 0° phase shift, I21 and I22 at 120° phase shift, and I31 and I32 at a 240° phase shift. Each such pair of diode currents is shifted with respect to another output current by one-third of the switching cycle (e.g., one-third of the switching cycle is 120° at the switching frequency fₛ). The trace 510 shows each diode current (when forward-conducted) includes a maximum value of around 15 amperes.

Waveform trace 520 shows the summed diode currents waveform, which shows the sum of the contributions of the diode currents I11, I12, I21, I22, I31, and I32. The summed secondary currents waveform indicates a ripple current that ranging from 24 to under 31 amperes, which is a ripple that varies by around 7 amperes (which is a substantial reduction as compared against the over 40 ampere range of currents in trace 420).

Waveform trace 530 shows the resulting (e.g., simulated) output voltage ripple of the output voltage Vout that is generated in response to a resistive load (e.g., R34), the capacitors C31, C32, C33, C34, C35, and C36, and the summed secondary currents waveform of trace 520. The ripple of the output voltage Vout is a ripple of less than 20 millivolts, which is a substantial reduction over the ripple of the voltage output ripple of trace 530. The reduction of the ripple facilitates, for example, the use of smaller inductors and capacitors to achieve a particular voltage ripple specification.

The process described herein for reducing input and output ripple components of a power converter includes summing successively delayed sinusoidal waveform components. As described hereinabove, three successively delayed sinusoidal components of nearly equal amplitudes can be summed to generate a virtually zero amount of ripple. The degree to which the three components sum when added result in zero ripple voltage is dependent on the fidelity of the summed sinusoidal waveform components, the degree to which they are of nearly equal amplitude and the accuracy with which two successive input waveforms are successively delayed relative to a first input waveform.

The summing of sinusoidal waveform components (e.g., to substantially reduce a ripple component at an input or an output of the power converter) can also be performed with six resonant power converters, each delayed with respect to another by 60°. In another example, the six series resonant power converters are grouped into two groups of three resonant power converters, with each resonant power converter delayed with respect to another in a respective group by 120°. In various examples, groups of series resonant power converters arranged in multiples of three can substantially reduce a ripple component at an input or an output of the power converter. Accordingly, the phasing of first, second, and third phase signals (e.g., Ps31, Ps32, and Ps33) can be separated from a successive phase signal by a phase interval that is an integer multiple of 60°.

The number of parallel resonant power converters selected to be included in a particular design can be dependent on the accuracy with which ripple components represent sinusoidal waveforms, the degree to which transients resulting from switching of the power switches are decoupled from the power converter input and output currents, and the practicality of manufacturing multiple power converters running in parallel.

Modifications are possible in the described embodiments, and other embodiments are possible, within the scope of the claims.

1. A circuit, comprising:
a first resonant power converters;
a second resonant power converters;
a third resonant power converter; and
a current summer coupled to receive a first rectified current from the first resonant power converter, a second rectified current from the second resonant power converter, and a third rectified current from the third resonant power converter;
wherein the first, second, and third power converters each include a first diode, a second diode, a first capacitor, and a second capacitor arranged in a voltage doubler configuration.

2. The circuit of claim 21, wherein the current summer is connected to an output of the first rectifier, an output of the second rectifier, and an output of the third rectifier.

3. The circuit of claim 21, wherein a first alternating-current (AC) component of the first sinusoidal output current, a second AC component of the second sinusoidal output current, and a third AC component of the third sinusoidal output current are mutually reduced by the current summer.

4. The circuit of claim 21, wherein the first phase signal indicates a phase difference of 120 degrees from a phase indicated by the second phase signal and a phase difference of 240 degrees from a phase indicated by the third phase signal.

5. (canceled)

6. The circuit of claim 21, further comprising a phase generator for generating the first, second, and third phase signals, wherein the first phase signal indicates a phase difference of 120 degrees from a phase indicated by the second phase signal and a phase difference of 240 degrees from a phase indicated by the third phase signal.

7. The circuit of claim 21, wherein the DC power input is generated by a DC power supply.

8. The circuit of claim 21, further comprising a resistive load for converting a sum of the first, second, and third rectified currents into an output voltage.

9. The circuit of claim 21, comprising a controller for generating the first, second, and third phase signals, wherein the each of the first, second, and third phase signals is separated from one another by a phase interval that is an integer multiple of 60 degrees.

10. A circuit, comprising:
a first resonant power converter, including:
a first periodic signal generator coupled to receive a direct-current (DC) power input and a first phase signal,
a first resonant network coupled to receive a first periodic voltage from the first periodic signal generator wherein the first periodic voltage includes a first voltage for a first time period and a second voltage for a second time period, and
a first rectifier coupled to receive a first sinusoidal output current from the first resonant network;
a second resonant power converter, including:
a second periodic signal generator coupled to receive the DC power input and a second phase signal,
a second resonant network coupled to receive a second periodic voltage from the second periodic signal generator wherein the second periodic voltage includes a first voltage for a first time period and a second voltage for a second time period, and
a second rectifier coupled to receive a second sinusoidal output current from the second resonant network;
a third resonant power converter, including:
a third periodic signal generator coupled to receive the DC power input and a third phase signal,
a third resonant network coupled to receive a third periodic voltage from the third periodic signal generator wherein the third periodic voltage includes a first voltage for a first time period and a second voltage for a second time period, and
a third rectifier coupled to receive a third sinusoidal output current from the third resonant network; and
a current summer coupled to receive a first rectified current from the first rectifier, a second rectified current from the second rectifier, and a third rectified current from the third rectifier
wherein the first, second, and third rectifiers each include a first second diode arranged in a voltage doubler configuration.

11. (canceled)

12. A system, comprising:
a controller for generating first, second, and third phase signals;
a first resonant power converter, including,
a first periodic signal generator for generating a first periodic voltage in response to a direct-current (DC) power input and the first phase signal wherein the first periodic voltage includes a first voltage for a first time period and a second voltage for a second time period,
a first resonant network for generating a first sinusoidal output current in response to the first periodic voltage, and
a first rectifier for rectifying the first sinusoidal output current to generate a first rectified current;
a second resonant power converter, including,
a second periodic signal generator for generating a second periodic voltage in response to the DC power input and the second phase signal wherein the second periodic voltage includes a first voltage for a first time period and a second voltage for a second time period,
a second resonant network for generating a second sinusoidal output current in response to the second periodic voltage, and
a second rectifier for rectifying the second sinusoidal output current to generate a second rectified current;
a third resonant power converter, including,
a third periodic signal generator for generating a third periodic voltage in response to the DC power input and the third phase signal wherein the third periodic voltage includes a first voltage for a first time period and a second voltage for a second time period,
a third resonant network for generating a third sinusoidal output current in response to the third periodic voltage, and
a third rectifier for rectifying the third sinusoidal output current to generate a third rectified current; and
a current summer for generating a total output current in response to summing the first, second, and third rectified currents;
wherein the first, second, and third rectifiers each include a first, a second diode, a first capacitor, and a second capacitor arranged in a voltage doubler configuration.

13. The system of claim 12, wherein the controller is arranged to generate the first, second, and third phase signals, and wherein the first phase signal indicates a phase difference of 120 degrees from a phase indicated by the second phase signal, and wherein the first phase signal indicates a phase difference of 240 degrees from a phase indicated by the third phase signal.

14. The system of claim 12, wherein the controller is arranged to generate fourth, fifth, and sixth phase signals.

15. (canceled)

16. The system of claim 14, further comprising:
a fourth resonant power converter, including:
a fourth periodic signal generator for generating a fourth periodic voltage in response to the DC power input and the fourth phase signal wherein the fourth periodic voltage includes a first voltage for a first time period and a second voltage for a second time period,
a fourth resonant network for generating a fourth sinusoidal output current in response to the fourth periodic voltage, and
a fourth rectifier for rectifying the fourth sinusoidal output current to generate a fourth rectified current;
a fifth resonant power converter, including:
a fifth periodic signal generator for generating a fifth periodic voltage in response to the DC power input and the fifth phase signal wherein the fifth periodic voltage includes a first voltage for a first time period and a second voltage for a second time period,
a fifth resonant network for generating a fifth sinusoidal output current in response to the fifth periodic voltage, and
a fifth rectifier for rectifying the fifth sinusoidal output current to generate a fifth rectified current; and
a sixth resonant power converter, including:
a sixth periodic signal generator for generating a sixth periodic voltage in response to the DC power input and the sixth phase signal wherein the sixth periodic voltage includes a first voltage for a first time period and a second voltage for a second time period,
a sixth resonant network for generating a sixth sinusoidal output current in response to the sixth periodic voltage, and
a sixth rectifier for rectifying the sixth sinusoidal output current to generate a sixth rectified current,
wherein the current summer is arranged to generate the total output current in response to summing the first, second, third, fourth, fifth, and sixth rectified currents.

17. A method comprising:
generating a first periodic voltage in response to a direct-current (DC) power input and a first phase signal wherein the first periodic voltage includes a first voltage for a first time period and a second voltage for a second time period;
generating a first sinusoidal output current in response to the first periodic voltage;
rectifying the first sinusoidal output current to generate a first rectified current;
generating a second periodic voltage in response to the DC power input and a second phase signal wherein the second periodic voltage includes a first voltage for a first time period and a second voltage for a second time period;
generating a second sinusoidal output current in response to the second periodic voltage;
rectifying the second sinusoidal output current to generate a second rectified current;
generating a third periodic voltage in response to the DC power input and a third phase signal wherein the third periodic voltage includes a first voltage for a first time period and a second voltage for a second time period;
generating a third sinusoidal output current in response to the third periodic voltage;
rectifying the third sinusoidal output current to generate a third rectified current;
generating a total output current in response to summing the first, second, and third rectified currents; and
doubling an output voltage derived from the total output current using a voltage doubler circuit.

18. The method of claim 17, comprising generating the first, second, and third phase signals.

19. The method of claim 18, wherein the first, second, and third phase signals are generated to differ in phase from one another by 120 degrees.

20. (canceled)

21. The circuit of claim 1,
wherein the first resonant power converter, includes:
a first periodic signal generator coupled to receive a direct-current (DC) power input and a first phase signal,
a first resonant network coupled to receive a first periodic voltage from the first periodic signal generator wherein the first periodic voltage includes a first voltage for a first time period and a second voltage for a second time period, and
a first rectifier coupled to receive a first sinusoidal output current from the first resonant network;
wherein the second resonant power converter includes:
a second periodic signal generator coupled to receive the DC power input and a second phase signal,
a second resonant network coupled to receive a second periodic voltage from the second periodic signal generator wherein the second periodic voltage includes a first voltage for a first time period and a second voltage for a second time period, and
a second rectifier coupled to receive a second sinusoidal output current from the second resonant network;
wherein the third resonant power converter includes:
a third periodic signal generator coupled to receive the DC power input and a third phase signal,
a third resonant network coupled to receive a third periodic voltage from the third periodic signal generator wherein the third periodic voltage includes a first voltage for a first time period and a second voltage for a second time period, and
a third rectifier coupled to receive a third sinusoidal output current from the third resonant network; and
wherein the current summer is coupled to receive the first rectified current from the first rectifier, the second rectified current from the second rectifier, and the third rectified current from the third rectifier.

22. The circuit of claim 10, wherein the current summer is connected to an output of the first rectifier, an output of the second rectifier, and an output of the third rectifier.

23. The circuit of claim 10, wherein the DC power input is generated by a DC power supply.

24. The circuit of claim 7, wherein the DC power supply includes:
a first terminal connected to the first, second, and third periodic signal generators, and
a second terminal directly connected to capacitors of the first, second, and third resonant networks.
